(19) United States
(12) Patent Application Publication
(10) Pub. No.: US 2013/0055504 A1
(43) Pub. Date: Mar. 7, 2013

(54) PNEUMATIC LIFTING CUSHION

(71) Applicants: Douglas E. Peash, Cheboygan, MI (US); Dale L. Peash, Rainier, WA (US); Michael C. Schmaltz, Tacoma, WA (US)

(72) Inventors: Douglas E. Peash, Cheboygan, MI (US); Dale L. Peash, Rainier, WA (US); Michael C. Schmaltz, Tacoma, WA (US)

(21) Appl. No.: 13/602,771

(22) Filed: Sep. 4, 2012

Related U.S. Application Data
(60) Provisional application No. 61/531,377, filed on Sep. 6, 2011.

(51) Int. Cl. A61G 5/14; F04B 35/04

(52) U.S. Cl. 5/654; 417/411

(57) ABSTRACT

A pneumatic lifting cushion is configured for easy carrying by a person and deployment upon substantially any seat. When seated thereon, a person may selectively inflate the lifting cushion using one or more of gas from a compressed gas cartridge, a gas pump, or from an auxiliary inflation gas source, and be urged into a standing position.

### CROSS REFERENCE TO RELATED APPLICATIONS

This application claims priority benefit under 35 U.S.C. §119(e) from, and to the extent not inconsistent with this application, incorporates by reference herein U.S. Provisional Patent Application Ser. No. 61/531,377; filed Sep. 6, 2011; entitled “PNEUMATIC LIFTING CUSHION”; invented by Douglas E. Peash, P.E.; Dale L. Peash; and Michael Charles Schmaltz.

### BACKGROUND

Some people have difficulty rising from a seated to a standing position. For example, people who have lost mobility as a result of arthritis, muscular dystrophy, multiple sclerosis, ALS, Parkinson's disease, degenerative joint diseases, and those with post operative conditions, etc. may have difficulty rising from a seated to a standing position. Similarly, other people may have insufficient strength to easily rise from a seated to a standing position. For example people who are obese, who have leg prostheses, and/or who have suffered a stroke may not be able to easily muster the strength to stand.

Currently there are a variety of lift chairs on the market, some of which provide mechanisms to elevate the seat portion of the chair to assist in translating from the sitting to semi-standing position. These chairs can be fitted with casters to provide a degree of mobility in the home.

There are also a variety of platform mounted lift chairs which have electrically powered seat and back sections which move to assist in translating from the sitting position to a standing position. This invention relates to an upper body lifting cushion which assists persons having a problem translating from a sitting to a standing position due to insufficient upper and/or lower body strength.

There are also portable powered seats on which the user sits on a movable 2.5 inch cushioned pad. The pad articulates to approximately 10 inches height when electrically powered to assist the user in translating from the sitting to semi-standing position. This type of seat weighs approximately 12 lbs.

There is a need for a lifting device that is light weight, that is truly portable, that may be carried unobtrusively, and/or that may be used to help a person rise from a variety of chairs, seats, benches, manual or electric-powered wheel chairs, and other seating surfaces that a person might encounter.

### SUMMARY

Embodiments according to the invention relate to a pneumatic lifting cushion adapted to assist persons having a problem translating from a sitting to a standing position. For example, this may be due to insufficient upper and/or lower body strength, neurological control, and/or obesity.

According to an embodiment, a pneumatic lifting cushion includes an inflatable cushion configured to be placed on a chair and sat upon by a person, a coupling operatively coupled to the inflatable cushion, and configured to receive a compressed gas cartridge, and an actuation valve configured to receive manual activation by the person to open a gas flow channel between the coupling and the inflatable cushion. Optionally, the pneumatic lifting cushion may include a coupling for receiving air from an external air pump or compressed air source.

According to embodiments, the pneumatic lifting cushion may provide one or more advantages over prior art. According to an embodiment, the pneumatic lifting cushion may urge the user from a sitting to semi-standing position in less than 30 seconds with the press of a button or lever. According to an embodiment, the pneumatic lifting cushion may incorporate a highly portable cushion and CO₂ or compressed air pressurizing system. This can allow the user to sit on a variety of level or uneven surfaces without discomfort. According to an embodiment, the pneumatic lifting cushion may be relatively light weight, for example less than 5 lbs. According to an embodiment, the pneumatic lifting cushion may not require external power for operation. According to an embodiment, the pneumatic lifting cushion may include a cushion that may be inflated via pressurized CO₂ or air stored in 88 gram (or larger) tanks/cartridges. The pneumatic lifting cushion may include an appropriate valve assembly to pressurize, provide over-pressure protection, and de-pressurize the cushion assembly. According to an embodiment, the pneumatic lifting cushion may include a stain resistant removable cover. For example, the removable cover may be made of an upholstery-like material and shaped to the contour of the cushion. The cover base may have a slip resistant surface. Surfaces may have appropriate spacing for ventilation. According to an embodiment, the pneumatic lifting cushion may be rolled or folded into a compact package for ease of transport.

According to an embodiment, a pneumatic lifting cushion may include a cushion assembly that may be inflated via an air pump such as a battery-powered diaphragm pump. The air pump may be integrated into the pneumatic lifting cushion. Optionally, the air pump and a battery for the air pump may be made according to a form factor that makes the air pump and battery interchangeable with a compressed gas cartridge. Optionally, the pneumatic lifting cushion may include a coupling for receiving air from an external air pump or compressed air source.

### BRIEF DESCRIPTION OF THE DRAWINGS

FIG. 1 is a perspective view of an inflated pneumatic lifting cushion, according to an embodiment.

FIG. 2 is a cross sectional plan view showing an internal structure of the pneumatic lifting cushion of FIG. 1, according to an embodiment.

FIG. 3 is a side sectional A-A view showing an internal structure of the pneumatic lifting cushion of FIGS. 1 and 2, according to an embodiment.

FIG. 4A is a side view of a valve assembly including a gas cartridge for the pneumatic lifting cushion of FIGS. 1, 2, and 3, according to an embodiment.

FIG. 4B is a section B-B bottom view of the valve assembly including a gas cartridge for the pneumatic lifting cushion of FIG. 4A, according to an embodiment.

FIG. 5A is a side view of a valve assembly including an air pump and battery for the pneumatic lifting cushion of FIGS. 1, 2, and 3, according to an embodiment.

FIG. 5B is a section C—C bottom view of the valve assembly including an air pump and battery for the pneumatic lifting cushion of FIG. 5A, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or and other changes may be made without departing from the spirit or scope of the disclosure.

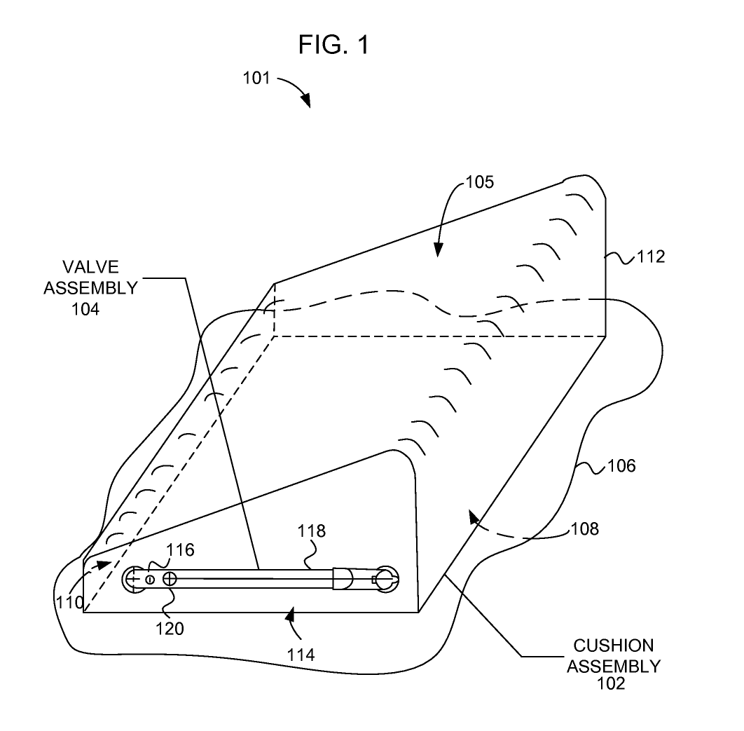

FIG. 1 is a perspective view of a pneumatic lifting cushion 101, according to an embodiment. FIG. 1 uses a substantially infinite vanishing point to keep edges parallel. The pneumatic lifting cushion 101 includes a cushion assembly 102, shown in an inflated configuration, and a valve assembly 104. In the inflated configuration, the cushion assembly has a top surface 105 that is raised relative to a surface 106 on which a bottom surface 108 of the cushion assembly 102 is placed. A front surface 110 is raised to a front inflation height, and a back surface 112 is raised to a back inflation height that is greater than the front inflation height. The front surface 110 is intended to be placed adjacent a front of a seat of a chair, and the back surface 112 is intended to be placed adjacent a back of the seat of the chair. The difference in front and back inflated heights creates a (soft) trapezoidal inflated side section that is configured to raise the buttocks of a person sitting on the top surface 105 while also tilting the person forward to help the person rise from a seated to a standing position.

The valve assembly 104 may be coupled to a side 114 of the cushion assembly 102. The valve assembly 104 includes a coupling 116 operatively coupled to the cushion assembly 102 and configured to receive a compressed gas cartridge 118. A pressurization valve includes a button 120 configured to receive manual activation by the person to open a gas flow channel between the coupling 116 and the cushion assembly 102 to raise the top surface 105 from a collapsed position relatively near the surface 106 to the raised height shown in FIG. 1.

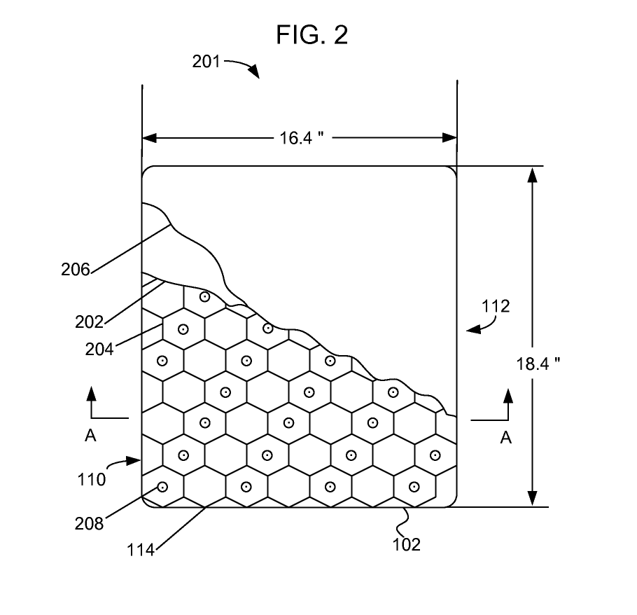

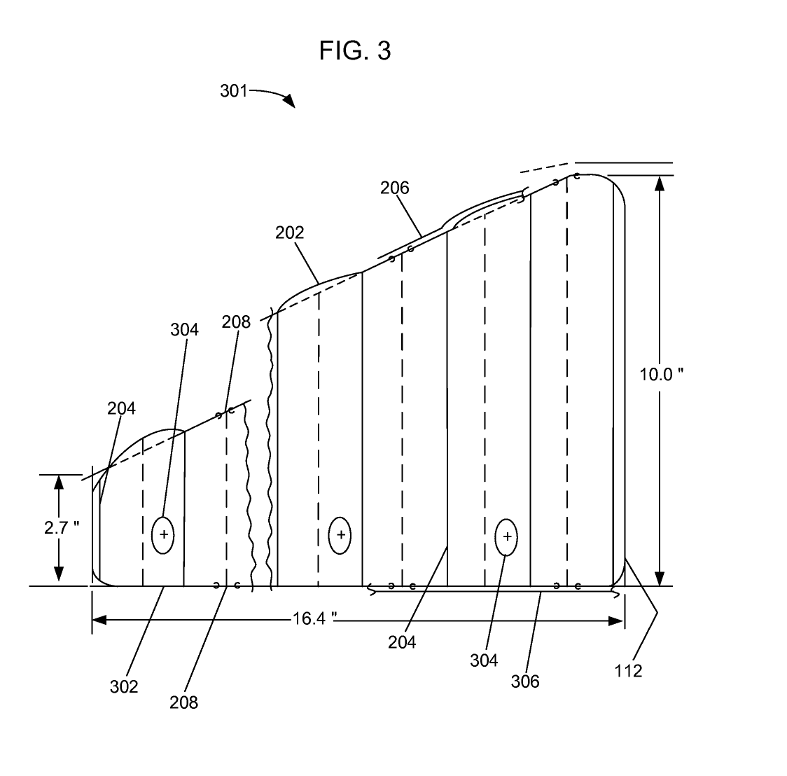

FIG. 2 is a cross-sectional plan view 201 of the pneumatic lifting cushion assembly 102 of FIG. 1, according to an embodiment. FIG. 3 is a side sectional A-A view 301 of the pneumatic lifting cushion assembly 102 of FIGS. 1 and 2 in an inflated configuration of the pneumatic lifting cushion assembly 102, according to an embodiment. FIG. 3 is a section taken along the plane A-A indicated in FIG. 2.

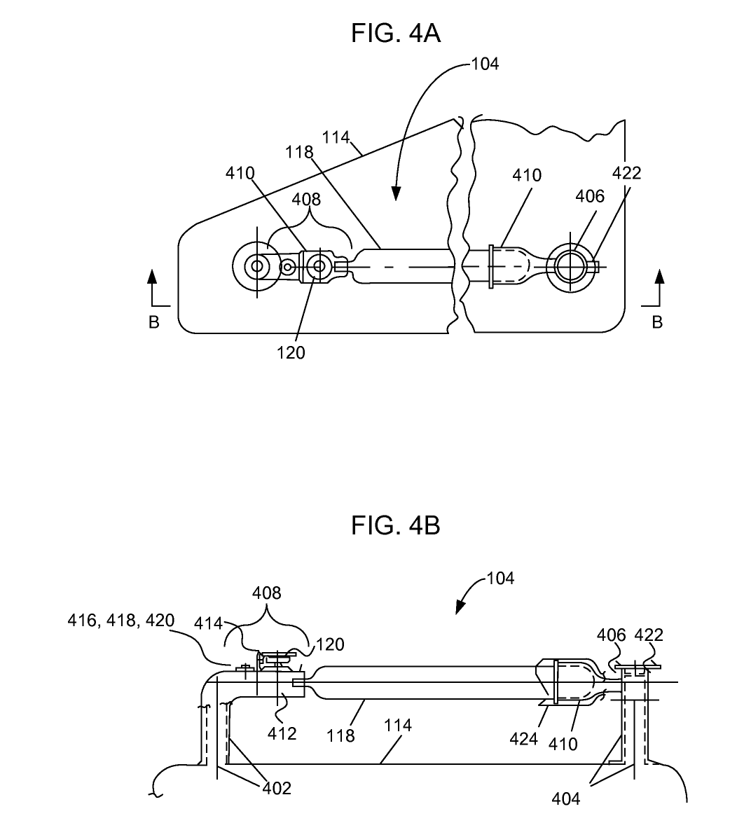

Referring to FIGS. 2 and 3, the a flexible upper surface panel 202 is bonded to the top surface of hex-cell honeycomb core 204 and top edge of the flexible vertical panels including side panels 114, front surface 110, and back surface 112. The flexible side panels 114, front surface 110, and back surface 112 extend continuously around the perimeter of the cushion assembly 102 to form a vertical pressure web of the cushion assembly 102. One of the flexible side panels 114 forms a mounting point for a supply port 402 and an exhaust port 404 shown in FIG. 4B. Optionally, the supply port 402 and/or the exhaust port 404 may be mounted onto the front surface 110 or the back surface 112.

Referring again to FIGS. 2 and 3, a flexible lower surface panel 302 is bonded to the lower surface of hex-cell honeycomb core 204, flexible side panels 114, a front surface 110, and a back surface 112 to form a pressure tight wedge shaped polygon or trapezoid. In one embodiment, all the cells in the core 204 may be inflated to raise a person. Optionally, less than all the cells in the core 204 may be inflated. For example, according to one embodiment, approximately 50% of the cells in the core 204 may be inflated, with the remainder of the cells remaining at substantially atmospheric pressure.

Vertical walls of the cells in the core 204 that are inflatable may include openings 304 to operatively couple the inflatable cells to one another. Thus, the inflatable cells may form an integral gas distribution manifold, with cells nearer the supply port 402 providing passages for transfer of gas to more distal cells. Optionally, one or more of the openings 304 may be coupled to one or more gas distribution manifolds (not shown) coupled to but formed separately from the cells themselves. The network of inflatable cells (and optionally the gas distribution manifold (not shown)) are operatively coupled to the cartridge 118 and the valve assembly 104 to allow the pressurized gas from the cartridge 118 to enter the cells through the openings 304 to inflate the cells. The cells are also operatively coupled to an exhaust valve 406 (FIG. 4) via the openings 304 to allow deflation of the cells and the cushion assembly 102.

Areas of the upper surface panel 202 and lower surface panel 302 corresponding to non-pressurized cells of the cell core 204 may include vent holes 208 that allow ambient air to escape and enter the cushion assembly 102 when being pressurized and deflated. The cushion assembly 102 has a fitted, removable cover assembly incorporating an upper/perimeter panel 206 of stain-resistant, breathable material and a slip-resistant breathable base panel 306. For example, the breathable base panel 306 may include small hooks such as a “Velcro-like” lower surface to resist wear and cling to the upholstered materials on which the cushion assembly 102 may be placed.

Optionally, the pneumatic lifting cushion 101 may provide substantially no cushioning when not inflated. For example, the covers and cells may be optimized to deflate to minimal thickness and minimal lumpiness. Alternatively, the pneumatic lifting cushion 101 may further include a foam or gel pad configured to prevent the structure of the inflatable cushion from causing pain to a person seated on the cushion.

According to an embodiment, at least some of the cells of the cell core 204 are configured to receive and temporarily hold compressed gas at approximately 1 pounds per square inch above atmospheric pressure (PSIG). Optionally, the at least some of the plurality of the cells of the cell core 204 may receive and temporarily hold compressed gas up to approximately 2 PSIG. The array of polygonal cells making up the cell core 204 may collectively occupy about 300 square inches.

FIGS. 4A and 4B depict the valve assembly 104 from two perspectives, according to an embodiment. The valve assembly 104 includes a coupling 408, 410 for a gas cartridge 118 (shown installed) and pressurization/de-pressurization equipment. The valve assembly 104 may incorporate a pressurization valve 412 and optional hinged safety cover 414, a pressurizing tank/cartridge 118, an exhaust valve 406, and an optional electronics assembly 416 that may include a visible indicator 418 and an audible beeper 420. The exhaust valve 406 is configured to open when the cushion assembly inflates to a pressure in excess of 2.0 psig. A pull tab 422 allows the valve to be opened manually to deflate the cushion assembly.

The optional electronics assembly 416 may include a range of components such as integrated or discrete, active or passive components. The optional electronics assembly 416 may include a battery. A 1.4 volt disk battery used in a wristwatch or hearing aid may provide a particularly compact power source. A pressure sensor (not shown) such as a pressure activated micro-switch may sense pressure in the cushion assembly. The electronics assembly 416 may be configured to illuminate a visible indicator 418 such as a light emitting diode (LED) and/or energize an audible beeper 420 when the cushion assembly 101 reaches a predetermined pressure.

For example, the coupling may be configured to receive a compressed carbon dioxide cartridge or a compressed air cartridge. The coupling gas cartridge holding assembly may be configured to receive one or more of a conventional soda bottle cartridge, a conventional pellet gun cartridge, a conventional BB gun cartridge, a conventional paintball gun cartridge, a conventional bicycle tire inflation cartridge, a conventional motorcycle tire inflation cartridge, an 88 gram cartridge, and/or a proprietary cartridge.

The valve assembly 104 is coupled to the cushion volume via a supply port 402 and an exhaust port 404. When the pressurization valve 412 is opened, gas from cartridge 118 is metered into the cushion volume via the supply port 402. For example, the pressurization valve 412 may include a constant pressure valve configured to inflate the cushion to a predetermined pressure. According to an embodiment, the pressure regulator and the actuation valve may be formed as an integrated device.

An exhaust port assembly 404 incorporates an exhaust valve 406 and fitted sleeve 410 to hold the base of pressurizing tank 118 in place and interface with flexible side panel 114. The supply port 402 may incorporate the electronics assembly 416 and pressurization valve 412, which supports the discharge end of the pressurizing tank or cartridge 118 and also interfaces with flexible side panel 114.

The valve assembly 104 may include a pressure regulator configured to reduce pressure from the compressed gas cartridge 118 to a pressure of approximately 0.5 to 2 pounds per square inch above atmospheric pressure. According to an embodiment, the pressure regulator may be adjustable to account for the body weight of the user. For example, for a cushion where half of the hexagonal cells of the cell core 204 in a 300 square inch pneumatic lifting cushion 101 are used to lift a 150 pound user, the pressure regulator may be set or adjusted to approximately 1 PSIG.

Optionally, a portion of the hexagonal cells may be selected for inflation based upon the weight of the person being lifted. For example, a 300 pound person may need to select inflation of 100% of the hexagonal cells to 1 PSIG. A 100 pound person may need to select 33% of the cells. Optionally, the portion of cells to be inflated may be selected by selection of a particular model of pneumatic cushion that is preconfigured to inflate a selected number of cells. Optionally, one or more gas distribution valves may be selectively configured to couple the gas inlet to various percentages of cells.

Optionally, the valve assembly 104 may include an apparatus configured to capture kinetic energy of admitted gas and use it to entrain air, for example as an eductor pump or turbo-pump. Optionally, the deflation valve may include a mechanism to rapidly depressurize the pneumatic lifting cushion 101. Such a mechanism may, for example, include a pump (such as an eductor pump or a turbo-pump) that is powered by a release of pressure from the gas canister 118.

According to an embodiment, the valve assembly 104 may provide a carrying handle for the cushion assembly 102. When configured as a carrying handle, the valve assembly 104 may be fitted with a removable cover 424 (shown in cutaway section) including an upholstered material similar to cover 206, for example. Alternatively, the cushion assembly 102 may include a separate carrying handle (not shown).

The handle may be mechanically coupled to the pneumatic lifting cushion 101 and adapted for carrying the pneumatic lifting cushion with one hand. For example, the handle may be configured to substantially contain the compressed gas cartridge. Optionally, the handle may be configured to substantially contain an installed compressed gas cartridge and a spare replacement cartridge.

Optionally, the pneumatic lifting cushion 101 may include an auxiliary inflation gas receiving fitting (not shown). For example, the auxiliary inflation gas receiving fitting may include a slip fitting, a screw-on fitting, and/or a quick disconnect coupling that is configured to couple to an inflation hose that may provide air from an external source.

Optionally, the pneumatic lifting cushion 101 may include a control valve, a valve selector, and/or a sensor to determine when an external source of inflation gas is connected and available for inflating the pneumatic lifting cushion. Optionally, the pneumatic lifting cushion 101 may include an electronic controller operatively coupled to the actuation valve, the coupling, and the auxiliary inflation gas receiving fitting. A selector, sensor, or sensing circuit operatively coupled to the electronic controller may be configured to determine whether an operable inflation gas source is operatively coupled to the auxiliary inflation gas receiving fitting. The electronic controller may be configured to operate according to an auxiliary inflation gas control logic when an operable inflation gas source is operatively coupled to the auxiliary inflation gas receiving fitting.

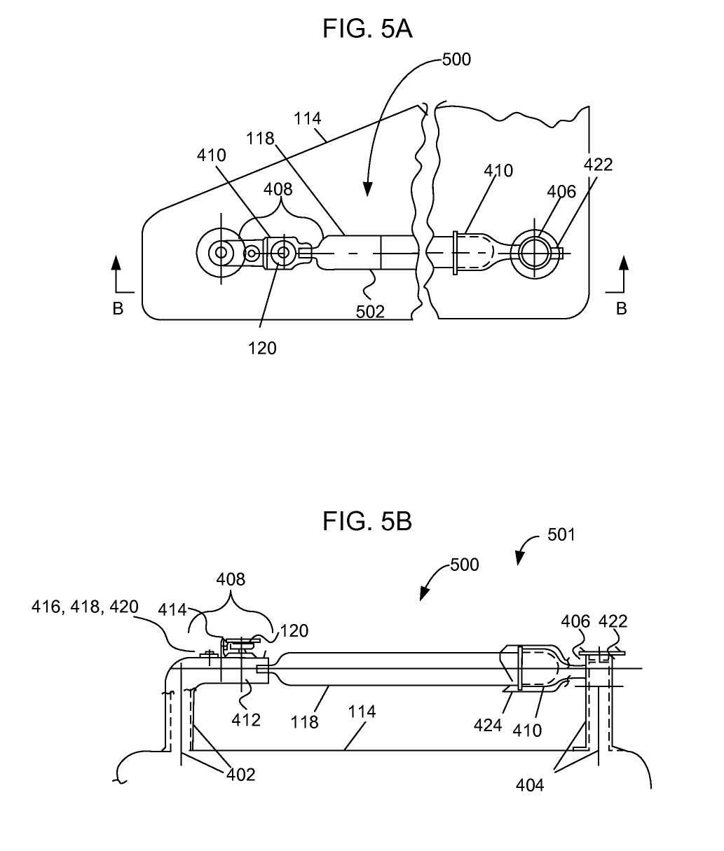

FIGS. 5A and 5B are views of an air pump and/or valve assembly 500 for the pneumatic lifting cushion of FIGS. 1, 2, and 3, according to an embodiment. The air pump and/or valve assembly 500 may include an air pump 501 and a battery 502 configured to power the air pump 501, and the air pump 501 configured to inflate the lifting cushion 101. Fittings or couplings 504, 505 may be similar in function to the gas cartridge fittings or couplings 408, 410. According to an embodiment, one or more air pressure supply and/or exhaust lines 503 may couple the air pump 501 to the valve assembly 408.

In an embodiment, the air pump 501 may be configured to inflate the pneumatic lifting cushion 101 directly when the button 101 is depressed. In another embodiment, the air pump 505 may be configured to pressurize a small gas pressure tank (not shown), and the pneumatic lifting cushion 101 may be inflated from the pressurized air in the small gas pressure tank. The air pump 501 may then operate automatically to recharge the small gas pressure tank in anticipation of the next inflation. The air pump 501 may, for example, include a diaphragm air pump such as model number 5132X made by DYNAFLO, Inc. of Birdsboro, Pa.

Optionally, the coupling 408, 410 configured to receive a compressed gas cartridge (see FIGS. 4A, 4B) may also be configured to alternatively receive the battery powered air pump 501. The actuation valve 412 may be configured to provide a signal to actuate the battery powered air pump assembly 501, 502. Optionally, an electronic controller 416 may be operatively coupled to the actuation valve 412 and the coupling 408, 410. A selector, sensor, or sensing circuit (not shown) may be configured to determine whether a compressed gas cartridge or a battery powered air pump 501, 502 is installed. The electronic controller 416 may be configured to operate according to a compressed gas cartridge control logic when the compressed gas cartridge (see FIGS. 4A, 4B, 118) is installed and configured to operate according to an air pump control logic when the battery powered air pump 501, 502 is installed.

As with the embodiment shown in FIGS. 4A, 4B, the pneumatic lifting cushion 101 may include an auxiliary inflation gas receiving fitting (not shown). The electronic controller 416 may be operatively coupled to the actuation valve 412, the coupling 408, 410, and the auxiliary inflation gas receiving fitting (not shown). A selector, sensor, or sensing circuit (not shown) may be configured to determine whether an operable inflation gas source is operatively coupled to the auxiliary inflation gas receiving fitting. The electronic controller 416 may be configured to operate according to an auxiliary inflation gas control logic when an operable inflation gas source is operatively coupled to the auxiliary inflation gas receiving fitting.

As indicated above, the assembly 500 may be made to optionally accept a compressed gas cartridge or a battery powered air pump. Accordingly, an inflation gas source 501, 503 may include a gas pump 501 and a battery 502 at least selectively operatively coupled to the gas pump 501. The gas pump 501 and the battery 502 may be configured to have a form factor corresponding to a compressed gas cartridge 416 (FIGS. 4A, 4B). The inflation gas source 501, 503 may include an electrical interface configured to receive an actuation signal to drive the gas pump 502. Alternatively or additionally, the inflation gas source 501, 503 may include a pressure sensor (not shown) configured to sense a gas pressure in a gas outflow volume (not shown) and an electronic controller (not shown) operatively coupled to the pressure sensor and the gas pump. The electronic controller may be configured to cause the gas pump to operate when pressure in the gas outflow volume decreases and to cause the gas pump to stop operating when the pressure in the gas outflow volume increases. In this way, the inflation gas source 501, 503 may simulate the behavior of a gas cartridge.

Operation of the pneumatic lifting cushion 101 may include the following steps:

1) Unroll or unfold the cushion assembly 102 and place it on an intended seating area (chair, couch, bench) with the valve assembly 104 oriented for convenient reach.

2) Sit on the deflated cushion assembly. The user may remain seated as long as desired;

3) When in the seated position and preparing to stand up: grasp the pressure cartridge 118 and with thumb or finger, lift safety cover 414 and press pressurization valve button 120, to pressurize the cushion. When the cushion is inflated to 2.0 psig, an optional LED lamp illuminates intermittently and an optional beeper sounds intermittently to provide visual and audio alerts that the cushion is fully inflated. If the user continues to press the valve button 120, a pressure relief valve, optionally combined with the exhaust valve 406, automatically opens to deflate the cushion assembly 102.

With continued use, a user may sense when the cushion is inflated before the visual/audio sensors activate. This will minimize pressurizing gas usage.

Inflation of the pneumatic lifting cushion 101 partially raises the user and, owing to the trapezoidal shape, helps the user bend forward. The user may then more easily rise to a standing position. After the user has transitioned from the seated to the standing position, he/she may deflate the cushion assembly by lifting the pull tab of the exhaust valve cover 422 over the exhaust valve 406. The exhaust valve cover 422, should be re-seated before the user prepares the cushion assembly for transport. In transport, the deflated pneumatic lifting cushion may be rolled up, or may be carried by the handle in a manner akin to a brief case. According to an embodiment, the pneumatic lifting cushion 101 may be configured to resemble a brief case when not inflated.

While the cells in the pneumatic lifting cushion are described as hexagonal, other shapes may be substituted without departing from the spirit or scope of the claims. For example, cylindrical cells may be packed into a lifting cushion. The size of the hexagonal cell may be changed. For example the size may be changed to improve stability when inflated and/or varied across the cushion to improve comfort and/or stability. In another embodiment, cubic or elongated cubic cells may be used. Accordingly, various cell shapes and sizes are contemplated and fall within the scope of the claims.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A pneumatic lifting cushion, comprising:
an inflatable cushion configured to be placed on a chair and sat upon by a person;
a coupling operatively coupled to the inflatable cushion, and configured to receive a compressed gas cartridge; and
an actuation valve configured to receive manual activation by the person to open a gas flow channel between the coupling and the inflatable cushion.

2. The pneumatic lifting cushion of claim 1, wherein the inflatable cushion contains a plurality of inflatable cells configure to contain an admitted compressed gas.

3. The pneumatic lifting cushion of claim 2, wherein the plurality of inflatable cells include hexagonal cells.

4. The pneumatic lifting cushion of claim 2, wherein a portion of the inflatable cells are configured to be inflated by the admitted compressed gas.

5. The pneumatic lifting cushion of claim 4, wherein the portion of the inflatable cells configured to be inflated is selected according to the weight of the person.

6. The pneumatic lifting cushion of claim 2, further comprising:
a selector valve configured to couple the gas flow channel to at least two different portions of the inflatable cells.

7. The pneumatic lifting cushion of claim 2, wherein the compressed gas is carbon dioxide or air.

8. The pneumatic lifting cushion of claim 1, wherein the coupling is configured to receive a compressed carbon dioxide or air cartridge.

9. The pneumatic lifting cushion of claim 8, wherein the compressed carbon dioxide or air cartridge includes one or more of a conventional soda bottle cartridge, a conventional pellet gun cartridge, a conventional BB gun cartridge, a conventional paintball gun cartridge, a conventional bicycle tire inflation cartridge, a conventional motorcycle tire inflation cartridge, an 88 gram cartridge, or a proprietary cartridge.

10. The pneumatic lifting cushion of claim 1, further comprising:
a handle mechanically coupled to the inflatable cushion and adapted for carrying the pneumatic lifting cushion with one hand.

11. The pneumatic lifting cushion of claim 10, wherein the handle is configured to substantially contain the compressed gas cartridge.

12. The pneumatic lifting cushion of claim 1, further comprising a pressure regulator configured to reduce pressure from the compressed gas cartridge to a pressure of approximately 1 pound per square inch above atmospheric pressure.

13. The pneumatic lifting cushion of claim 1, wherein the pressure regulator and the actuation valve comprise an integrated device.

14. The pneumatic lifting cushion of claim 1, wherein the pneumatic lifting cushion is configured to resemble a brief case when not inflated.

15. The pneumatic lifting cushion of claim 1, wherein the inflatable cushion provides substantially no cushioning when not inflated.

16. The pneumatic lifting cushion of claim 1, further comprising a foam or gel pad configured to prevent the structure of the inflatable cushion from causing pain to a person seated on the cushion.

17. The pneumatic lifting cushion of claim 1, wherein the inflatable cushion contains a plurality of polygonal cells, at least some of which are configured to receive and temporarily hold compressed gas at approximately 1 PSIG, the plurality of polygonal cells collectively occupying about 300 square inches.

18. The pneumatic lifting cushion of claim 1, further comprising at least one pump powered by the compressed gas.

19. The pneumatic lifting cushion of claim 18, wherein at least pump is configured to pump air into the inflatable cushion to inflate the cushion.

20. The pneumatic lifting cushion of claim 18, wherein at least one pump is configured to pump gas out of the inflatable cushion to deflate the cushion.

21. The pneumatic lifting cushion of claim 18, wherein the at least one pump includes one or more of an eductor pump or a turbo pump.

22. The pneumatic lifting cushion of claim 1, wherein the coupling configured to receive a compressed gas cartridge is also configured to alternatively receive a battery powered air pump.

23. The pneumatic lifting cushion of claim 22, wherein the actuation valve is further configured to provide a signal to actuate the battery powered air pump.

24. The pneumatic lifting cushion of claim 22, further comprising:
an electronic controller operatively coupled to the actuation valve and the coupling; and
a selector, sensor, or sensing circuit configured to determine whether a compressed gas cartridge or a battery powered air pump is installed;
wherein the electronic controller is configured to operate according to a compressed gas cartridge control logic when the compressed gas cartridge is installed and configured to operate according to an air pump control logic when the battery powered air pump is installed.

25. The pneumatic lifting cushion of claim 1, further comprising:
an auxiliary inflation gas receiving fitting;
an electronic controller operatively coupled to the actuation valve, the coupling, and the auxiliary inflation gas receiving fitting; and
a selector, sensor, or sensing circuit configured to determine whether an operable inflation gas source is operatively coupled to the auxiliary inflation gas receiving fitting;
wherein the electronic controller is configured to operate according to an auxiliary inflation gas control logic when an operable inflation gas source is operatively coupled to the auxiliary inflation gas receiving fitting.

26. An apparatus for partially lifting a seated person from a seating surface, comprising:
an inflatable cushion;
a fitting configured to receive a compressed gas tank; and
a first pump powered by compressed gas from the tank, the first pump being configured to pump air into the inflatable cushion.

27. The apparatus for partially lifting a seated person of claim 26, further comprising:
a second pump powered by compressed gas from the tank, the second pump being configured to pump air out of the inflatable cushion.

28. The apparatus for partially lifting a seated person of claim 27, wherein the first and second pumps are the same pump.

29. The apparatus for partially lifting a seated person of claim 26, wherein the first pump includes a plurality of pumps.

30. The apparatus for partially lifting a seated person of claim 26, wherein the first pump includes one or more of an eductor pump or a turbo pump.

31. A method for partially lifting a person comprising:
receiving inflation gas from an inflation gas source;
using the received inflation gas to fill a pneumatic cushion to lift the person.

32. The method for partially lifting a person of claim 31, wherein using the received inflation gas to fill the pneumatic cushion includes directing the inflation gas into the pneumatic cushion.

33. The method for partially lifting a person of claim 31, wherein using the received inflation gas to fill the pneumatic cushion includes actuating a pump to pump air into the cushion.

34. The method for partially lifting a person of claim 31, wherein using the received inflation gas to fill the pneumatic cushion includes receiving the inflation gas from a compressed gas cartridge.

35. The method for partially lifting a person of claim 31, further comprising:
receiving a manual actuation from a person seated on the pneumatic cushion; and wherein
receiving the compressed gas and using the received compressed gas to fill the pneumatic cushion are performed responsive to the manual actuation.

36. The method for partially lifting a person of claim 31, further comprising:
sensing when the pneumatic cushion reaches a predetermined state of inflation; and
activating an indicator to inform the person that the inflation of the pneumatic cushion is substantially complete.

37. The method for partially lifting a person of claim 36, wherein activating an indicator includes one or more of activating an illuminator, activating a beeper, releasing pressure through a pressure relief valve, or emitting a sound with a pressure relief valve.

38. The method for partially lifting a person of claim 31, wherein the pneumatic cushion includes a plurality of inflation cells.

39. The method for partially lifting a person of claim 38, further comprising:
selecting a portion of the inflation cells to inflate as a function of the weight of the person.

40. The method for partially lifting a person of claim 39, wherein selection of the portion of the inflation cells is made by selecting a model of cushion.

41. The method for partially lifting a person of claim 39, wherein selection of the portion of the inflation cells is made by setting a valve position.

42. An inflation gas source, comprising:
a gas pump; and
a battery at least selectively operatively coupled to the gas pump;
wherein the gas pump and the battery are configured to have a form factor corresponding to a compressed gas cartridge.

43. The inflation gas source of claim 42, wherein the inflation gas source further comprises:
an electrical interface configured to receive an actuation signal to drive the gas pump.

44. The inflation gas source of claim 42, wherein the inflation gas source further comprises:
a pressure sensor configured to sense a gas pressure in a gas outflow volume; and
an electronic controller operatively coupled to the pressure sensor and the gas pump;
wherein the electronic controller is configured to cause the gas pump to operate when pressure in the gas outflow volume decreases and to cause the gas pump to stop operating when the pressure in the gas outflow volume increases.
